(19) United States
(12) Patent Application Publication
(10) Pub. No.: US 2007/0243428 A1
(43) Pub. Date: Oct. 18, 2007

(54) Method of commencing operation of an electrochemical fuel cell stack from freeze-start conditions

(76) Inventors: Christopher J. Richards, New Westminster (CA); Bruce Lin, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/288,972

(22) Filed: Nov. 29, 2005

(51) Int. Cl. H01M 8/04

(52) U.S. Cl. 429/14

(57) ABSTRACT

A method of commencing operation of an electrochemical fuel cell stack from freeze-start conditions is disclosed. The method comprises detecting the temperature of the electrochemical fuel cell stack, detecting the temperature of the ambient environment, and, if the temperature of the electrochemical fuel cell stack is below the freezing temperature of water, (i) supplying fuel and oxidant reactant streams to the electrochemical fuel cell stack, wherein the temperature of at least one reactant stream is above the temperature of the ambient environment, and (ii) drawing electric current from the electrochemical fuel cell stack.

### BACKGROUND OF THE INVENTION

1. Field of the Invention

The present invention relates generally to methods of operating electrochemical fuel cell stacks, and, more particularly, to methods of commencing operation of electrochemical fuel cell stacks from freeze-start conditions.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes. The location of the electrocatalyst generally defines the electrochemically active area.

One type of electrochemical fuel cell is the polymer electrolyte membrane (PEM) fuel cell. PEM fuel cells generally employ a membrane electrode assembly (MEA) comprising a solid polymer electrolyte or ion-exchange membrane disposed between two electrodes. Each electrode typically comprises a porous, electrically conductive substrate, such as carbon fiber paper or carbon cloth, which provides structural support to the membrane and serves as a fluid diffusion layer. The membrane is ion conductive (typically proton conductive), and acts both as a barrier for isolating the reactant streams from each other and as an electrical insulator between the two electrodes. A typical commercial PEM is a sulfonated perfluorocarbon membrane sold by E.I. Du Pont de Nemours and Company under the trade designation NAFION®. The electrocatalyst is typically a precious metal composition (e.g., platinum metal black or an alloy thereof) and may be provided on a suitable support (e.g., fine platinum particles supported on a carbon black support).

In a fuel cell, an MEA is typically interposed between two separator plates that are substantially impermeable to the reactant fluid streams. The plates typically act as current collectors and provide support for the MEA. In addition, the plates may have reactant channels formed therein and act as flow field plates providing access for the reactant fluid streams to the respective porous electrodes and providing for the removal of reaction products formed during operation of the fuel cell.

In a fuel cell stack, a plurality of fuel cells are connected together, typically in series, to increase the overall output power of the assembly. In such an arrangement, one side of a given separator plate may serve as an anode flow field plate for one cell and the other side of the plate may serve as the cathode flow field plate for the adjacent cell. In this arrangement, the plates may be referred to as bipolar plates. Typically, a plurality of inlet ports, supply manifolds, exhaust manifolds and outlet ports are utilized to direct the reactant fluid to the reactant channels in the flow field plates. In addition, further inlet ports, supply manifolds, exhaust manifolds and outlet ports are utilized to direct a coolant fluid to interior passages within the fuel cell stack to absorb heat generated by the exothermic reaction in the fuel cells. The supply and exhaust manifolds may be internal manifolds, which extend through aligned openings formed in the flow field plates and MEAs, or may comprise external or edge manifolds, attached to the edges of the flow field plates.

A broad range of reactants can be used in PEM fuel cells. For example, the fuel stream may be substantially pure hydrogen gas, a gaseous hydrogen-containing reformate stream, or methanol in a direct methanol fuel cell. The oxidant may be, for example, substantially pure oxygen or a dilute oxygen stream such as air.

During normal operation of a PEM fuel cell, fuel is electrochemically oxidized on the anode side, typically resulting in the generation of protons, electrons, and possibly other species depending on the fuel employed. The protons are conducted from the reaction sites at which they are generated, through the membrane, to electrochemically react with the oxidant on the cathode side. The electrons travel through an external circuit providing useable power and then react with the protons and oxidant on the cathode side to generate water reaction product.

The preferred operating temperature range for PEM fuel cells is typically between 50° C. to 120° C. Under many conditions, start-up of an electrochemical fuel cell stack is under high ambient temperatures and the fuel cell stack can be started in a reasonable amount of time and quickly brought to the preferred operating temperature. However, in some fuel cell applications, it may be necessary or desirable to commence operation of an electrochemical fuel cell stack when the temperature of the fuel cell stack (e.g., the stack core temperature) is below the freezing temperature of water (0° C.) (commonly referred as “freeze-start” conditions), or even at subfreezing temperatures of −20° C. or less. Start-ups from such subzero temperatures are commonly referred to as “freeze-starts” or “freeze-startups”. At such low temperatures, the fuel cell stack does not operate well and rapid start-up of the fuel cell stack is more difficult. It may thus take a considerable amount of time and/or energy to take an electrochemical fuel cell stack from a cold starting temperature, for example, below the freezing temperature of water, up to an efficient operating temperature. Furthermore, supply of the desired power, for example, 50% full power, 80% full power or 100% full power, may be hindered until the fuel cell stack warms up to its normal operating temperature.

A variety of techniques have been developed to address this issue. For example, fuel cell systems have been designed which comprise additional heating elements and/or heat-exchanging subsystems to supply heat to, and quickly increase the temperature of, the fuel cell stack. However, such systems require additional equipment solely for start-up purposes and typically require a net input of energy during start-up, thereby both increasing the complexity, and decreasing the efficiency, of the system. Another technique involves insulating the fuel cell stack itself and, in this way, slowing the cooling of the fuel cell stack. Thus, if the temperature of the ambient environment is at or below the freezing temperature of water, the temperature of the insulated fuel cell stack may stay above freezing for some extended period of time following shut down, thereby permitting more favorable starting conditions should the stack be restarted during this period of time. However, since such insulated systems merely slow the cooling process, freeze-start conditions will remain a problem following long periods of fuel cell stack inactivity.

In U.S. Pat. No. 5,798,186, yet another method of heating a cold MEA to accelerate the start-up of a PEM fuel cell from freeze-start conditions is disclosed. As described in the '186 patent, electric current is drawn from the fuel cell stack as quickly as possible, thereby generating waste heat from the exothermic reaction in the fuel cells and locally heating the ion-exchange membrane from below freezing to a suitable operating temperature. However, under freeze-start conditions, water and/or ice will be produced on the cathode side and, after a sufficient accumulation thereof, fuel cell performance will decrease and start-up may fail.

Accordingly, although there have been advances in the field, there remains a need in the art for efficient methods of starting fuel cell stacks at low and sub-freezing temperatures. The present invention addresses these needs and provides further related advantages.

### BRIEF SUMMARY OF THE INVENTION

In brief, the present invention is directed methods of operating electrochemical fuel cell stacks, and, more particularly, to methods of commencing operation of electrochemical fuel cell stacks from freeze-start conditions.

In one embodiment, a method of commencing operation of an electrochemical fuel cell stack from freeze-start conditions is disclosed. The method comprises: (a) detecting the temperature of the electrochemical fuel cell stack; (b) detecting the temperature of the ambient environment; and (c) if the temperature of the electrochemical fuel cell stack is below the freezing temperature of water: (i) supplying fuel and oxidant reactant streams to the electrochemical fuel cell stack, wherein the temperature of at least one reactant stream is above the temperature of the ambient environment; and (ii) drawing electric current from the electrochemical fuel cell stack.

In more specific embodiments, the temperature of the fuel reactant stream is above the temperature of the ambient environment, the temperature of the oxidant reactant stream is above the temperature of the ambient environment, or the temperatures of both the fuel and oxidant reactant streams are above the temperature of the ambient environment.

In further embodiments, the method further comprises, if the temperature of the electrochemical fuel cell stack is below the freezing temperature of water, a step of heating the at least one reactant stream having a temperature above the temperature of the ambient environment prior to the step of supplying the reactant streams to the electrochemical fuel cell stack.

In more specific embodiments of the foregoing, the step of heating the at least one reactant stream comprises flowing the at least one reactant stream through a heated reactant inlet feed tube upstream of the electrochemical fuel cell stack. In certain embodiments, the reactant inlet feed tube may be heated by an electric heater.

In other more specific embodiments, the step of heating the at least one reactant stream comprises flowing the at least one reactant stream through at least one compressor upstream of the electrochemical fuel cell stack. In certain embodiments, the at least one compressor may be operated in a manner such that excess waste heat is generated.

These and other aspects of the invention will be evident upon reference to the following detailed description and attached drawings.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a representative electrochemical fuel cell system according to a first embodiment.

FIG. 2 is a schematic diagram of a representative electrochemical fuel cell system according to a second embodiment.

FIG. 3 is a flow chart showing various steps associated with a representative method of commencing operation of an electrochemical fuel cell stack from freeze-start conditions.

FIG. 4 is a graph showing the relationship between the water vapor pressure and temperature of a representative reactant stream.

FIG. 5 is a graph showing the power profile of a representative fuel cell stack with freeze-start time.

FIG. 6 is a graph showing the temperature profiles of the oxidant and coolant reactant streams of a representative fuel cell stack with freeze-start time.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, fuel cell systems have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As discussed in U.S. Pat. No. 5,798,186 (which patent was noted above and is incorporated herein by reference in its entirety), when operation of a fuel cell stack is commenced from freeze-start conditions, heat generated by the exothermic reactions in the fuel cells contributes to raising the stack core temperature above the freezing temperature of water. However, under such freeze-start conditions, water and/or ice will be produced on the cathode side and, after a sufficient accumulation thereof, fuel cell performance will decrease and start-up time may increase, or start-up may fail. Accordingly, the existing approach is to draw electric current as quickly as possible from the fuel cell stack in an attempt to heat the fuel cell stack and deliver power as quickly as possible, while minimizing the effects of any accumulated water and/or ice. However, as one of ordinary skill in the art will appreciate, such efforts may result in long freeze-start times.

It has now been found that heating up at least one of the reactant streams prior to supplying it to the fuel cell stack decreases the freeze-start time of the fuel cell stack from low temperatures. When combined with the method disclosed in the '186 patent, the amount of electric current drawn from the fuel cell stack necessary to minimize the effects of any accumulated water and/or ice is reduced. Furthermore, since only the reactant streams are being heated (i.e., the fuel cell stack itself may remain cold—insulation of the reactant manifolds will enable the reactant streams to retain heat), the disclosed method requires the input of less energy during start-up than convention methods in which the entire fuel cell stack or a portion of the fuel cell stack is warmed.

Accordingly, the present invention provides an improved method of commencing operation of an electrochemical fuel cell stack from freeze-start conditions. As noted above, the method comprises: (a) detecting the temperature of the electrochemical fuel cell stack; (b) detecting the temperature of the ambient environment; and (c) if the temperature of the electrochemical fuel cell stack is below the freezing temperature of water: (i) supplying fuel and oxidant reactant streams to the electrochemical fuel cell stack, wherein the temperature of at least one reactant stream is above the temperature of the ambient environment; and (ii) drawing electric current from the electrochemical fuel cell stack. Furthermore, the method may further comprise, if the temperature of the electrochemical fuel cell stack is below the freezing temperature of water, a step of heating the at least one reactant stream having a temperature above the temperature of the ambient environment prior to the step of supplying the reactant streams to the electrochemical fuel cell stack.

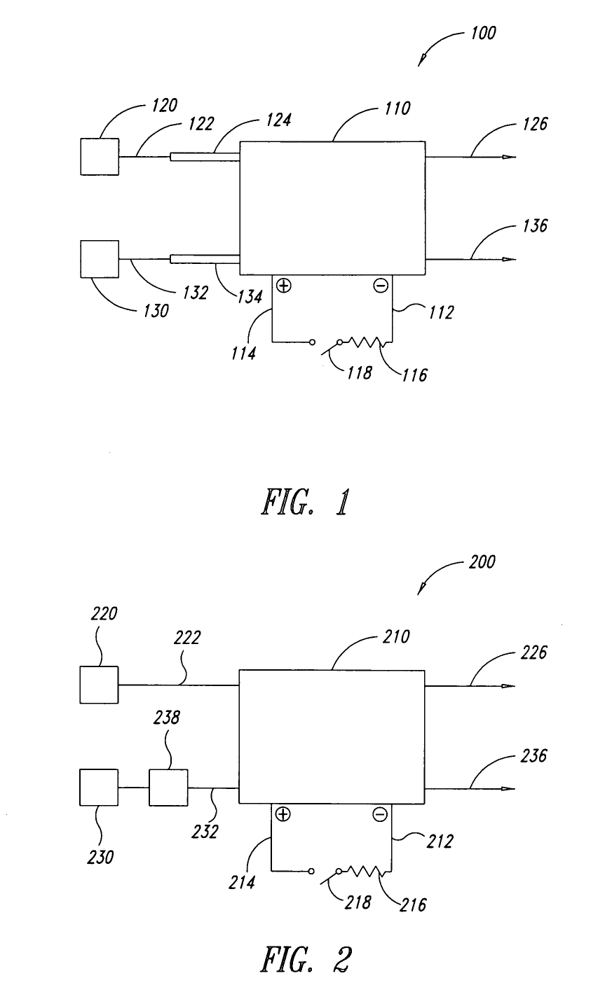

FIG. 1 is a schematic diagram of a representative electrochemical fuel cell system 100 according to a first embodiment. As shown fuel cell system 100 comprises an electrochemical fuel cell stack 110 having negative and positive terminals 112, 114, respectively, to which an external circuit comprising a variable load 116 is electrically connectable by closing switch 118. As one of ordinary skill in the art will appreciate, in other representative embodiments, the external circuit electrically connectable to fuel cell stack 110 may comprise additional and/or different components and will not be exemplified any further. A fuel reactant stream is supplied to fuel cell stack 110 from a fuel supply 120 through a fuel inlet line 122, and is exhausted from fuel cell stack 110 through a fuel exhaust line 126. Similarly, an oxidant reactant stream is supplied to fuel cell stack 110 from an oxidant supply 130 through an oxidant inlet line 132, and is exhausted from fuel cell stack 110 through an oxidant exhaust line 136.

In the embodiment shown in FIG. 1, both the fuel and oxidant reactant streams may be heated to a temperature (Tᵣ) above the temperature of the ambient environment (Tₐ) by flowing the reactant streams through heated reactant inlet feed tubes 124, 134 upstream of fuel cell stack 110. As noted above, in other embodiments, only one of the reactant streams may be heated. As one of ordinary skill in the art will appreciate, various means for heating reactant inlet feed tubes 124, 134 may be employed. For example, reactant inlet feed tubes 124, 134 may be heated by one or more electric heaters or by combustion upstream of the fuel cell stack. Alternatively, or in combination, when the fuel cell stack initially draws power, heating of the reactant streams may be accelerated by heat exchanging the reactant streams with a heated water reservoir, an insulated thermal reservoir, the fuel cell stack coolant exhaust or the fuel cell stack itself as it warms up, or by other methods known to one of ordinary skill in the art.

To commence operation of fuel cell stack 110, after receiving a request signal for a supply of power, at least one of the temperature of fuel cell stack 110 (Tₛ) and the temperature of the ambient environment surrounding fuel cell stack 110 (Tₐ) are measured using at least one temperature sensor (not specifically shown) capable of detecting at least one of Tₛ and Tₐ. Suitable temperature sensors in this regard are well known to those of ordinary skill in the art and need not be further exemplified. If Tₛ is below the freezing temperature of water (0° C.), operation of fuel cell stack 110 is commenced by supplying the heated fuel and oxidant reactant streams to fuel cell stack 110 and drawing electric current from fuel cell stack 110 by closing switch 118 and adjusting variable load 116.

FIG. 2 is a schematic diagram of an alternative representative electrochemical fuel cell system 200 according to a second embodiment. As shown fuel cell system 200 comprises an electrochemical fuel cell stack 210 having negative and positive terminals 212, 214, respectively, to which an external circuit comprising a variable load 216 is electrically connectable by closing switch 218. As one of ordinary skill in the art will appreciate, in other representative embodiments, the external circuit electrically connectable to fuel cell stack 210 may comprise additional and/or different components and will not be exemplified any further. A fuel reactant stream is supplied to fuel cell stack 210 from a fuel supply 220 through a fuel inlet line 222, and is exhausted from fuel cell stack 210 through a fuel exhaust line 226. Similarly, an oxidant reactant stream is supplied to fuel cell stack 210 from an oxidant supply 230 through an oxidant inlet line 232, and is exhausted from fuel cell stack 210 through an oxidant exhaust line 236.

In the embodiment shown in FIG. 2, the oxidant reactant stream is heated to a temperature (Tᵣ) above the temperature of the ambient environment (Tₐ) by flowing the oxidant reactant stream through at least one compressor 238 upstream of fuel cell stack 210, which heats the reactant stream. As noted above, in other embodiments, the fuel reactant stream may instead be heated or both of the reactant streams may be heated. Conventional compressors utilized in fuel cell systems typically raise the temperature of the compressed reactant stream by approximately 150° C. Although many fuel cell systems employ a compressor intercooler downstream of the compressor to subsequently lower the temperature of reactant stream to a desired temperature, such compressor intercoolers may be shut-off or bypassed in the present embodiment. Furthermore, as one of ordinary skill in the art will appreciate, compressor 238 may be operated in various different ways in order provide the required amount of heating. For example, compressor 238 may be intentionally operated in an inefficient manner such that excess waste heat is generated, the flow rate of the reactant stream through compressor 238 may be slowed such that the compressor exhaust temperature rises. Alternatively, the compressor intercooler may be slowed down or stopped to allow the temperature of the compressor, and thus the reactants flowing therethrough, to increase.

Similar to fuel cell stack 110 in FIG. 1, to commence operation of fuel cell stack 210, after receiving a request signal for a supply of power, the temperature of fuel cell stack 210 (Tₛ) and the temperature of the ambient environment surrounding fuel cell stack 210 (Tₐ) are measured using a first temperature sensor (not specifically shown) capable of detecting Tₛ and a second temperature sensor (not specifically shown) capable of detecting Tₐ. Suitable temperature sensors in this regard are well known to those of ordinary skill in the art and need not be further exemplified. If Tₛ is below the freezing temperature of water (0° C.), operation of fuel cell stack 210 is commenced by supplying the fuel and heated oxidant reactant streams to fuel cell stack 210 and drawing electric current from fuel cell stack 210 by closing switch 218 and adjusting variable load 216.

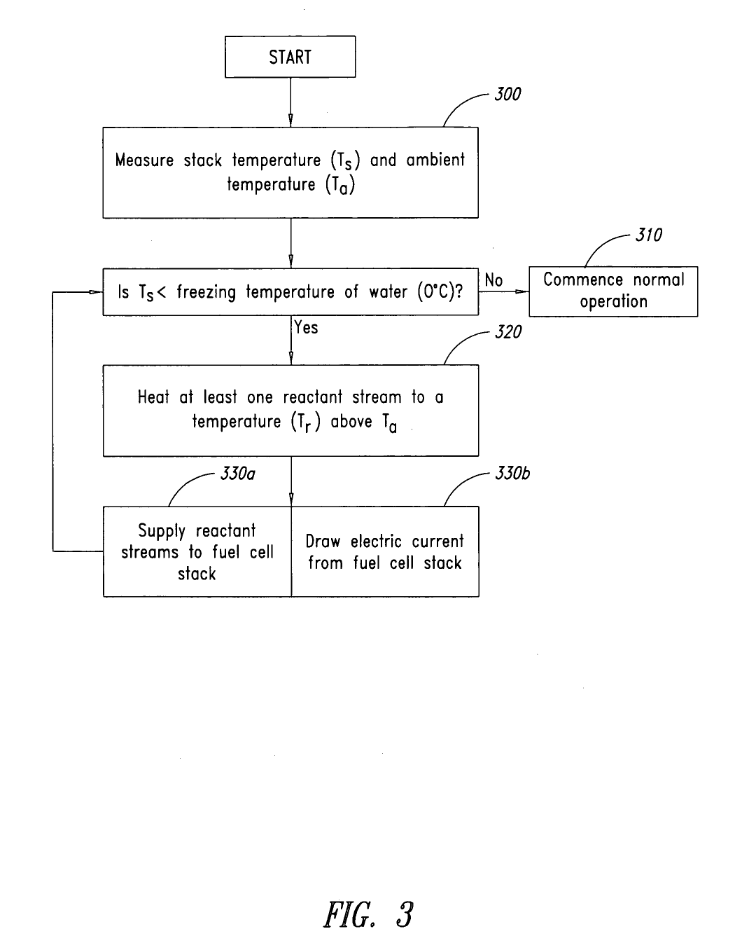

FIG. 3 is a flow chart showing various steps associated with a representative method of commencing operation of an electrochemical fuel cell stack from freeze-start conditions. As shown, in step 300, the temperature of the electrochemical fuel cell stack (Tₛ) and the temperature of the ambient environment (Tₐ) are measured. If Tₛ is above the freezing temperature of water (0° C.), then normal operation of the fuel cell stack may be commenced, as shown by step 310. If, however, Tₛ is below the freezing temperature of water (0° C.), then the fuel and oxidant reactant streams are supplied to the electrochemical fuel cell stack and electric current is drawn from the electrochemical fuel cell stack, as shown by steps 330a and 330b, respectively. As described previously, the temperature of at least one of the reactant streams (Tᵣ) is above Tₐ. In addition, as shown in FIG. 3, steps 330a and 330b occur at the same time, rather than sequentially. As further shown in FIG. 3, there may also be a step 320, prior to steps 330a and 330b, wherein at least one of the reactant streams is heated to a temperature (Tᵣ) above Tₐ. Following steps 330a and 330b, if Tₛ is above the freezing temperature of water (0° C.), then normal operation of the fuel cell stack may be commenced. Alternatively, if Tₛ is still below the freezing temperature of water (0° C.), steps 320, 330a and 330b may be continued as required to raise Tₛ.

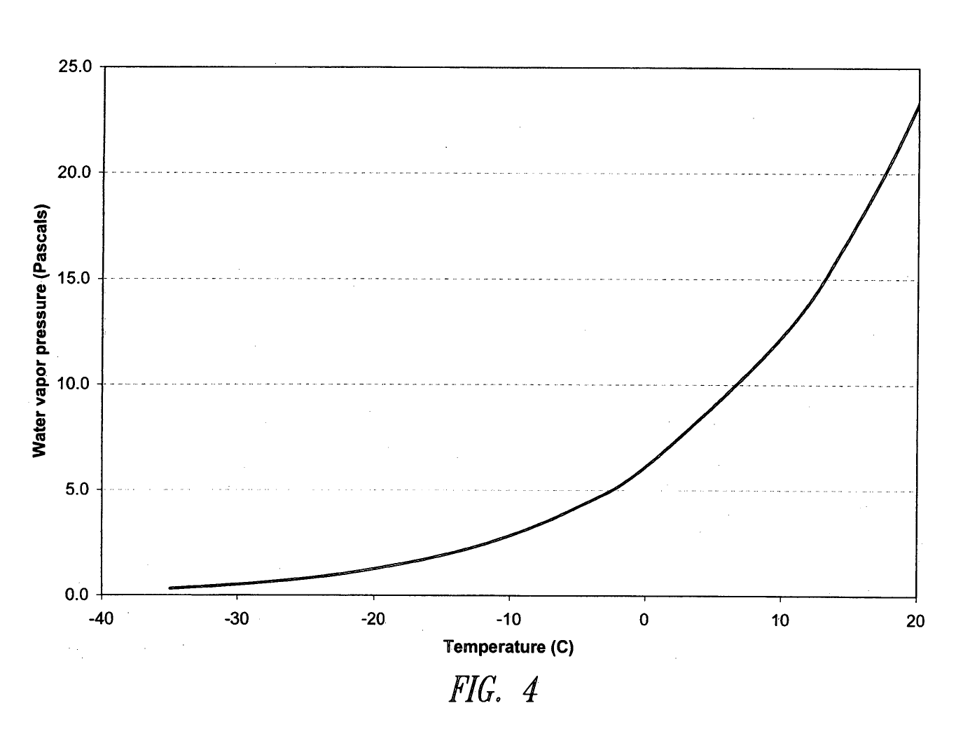

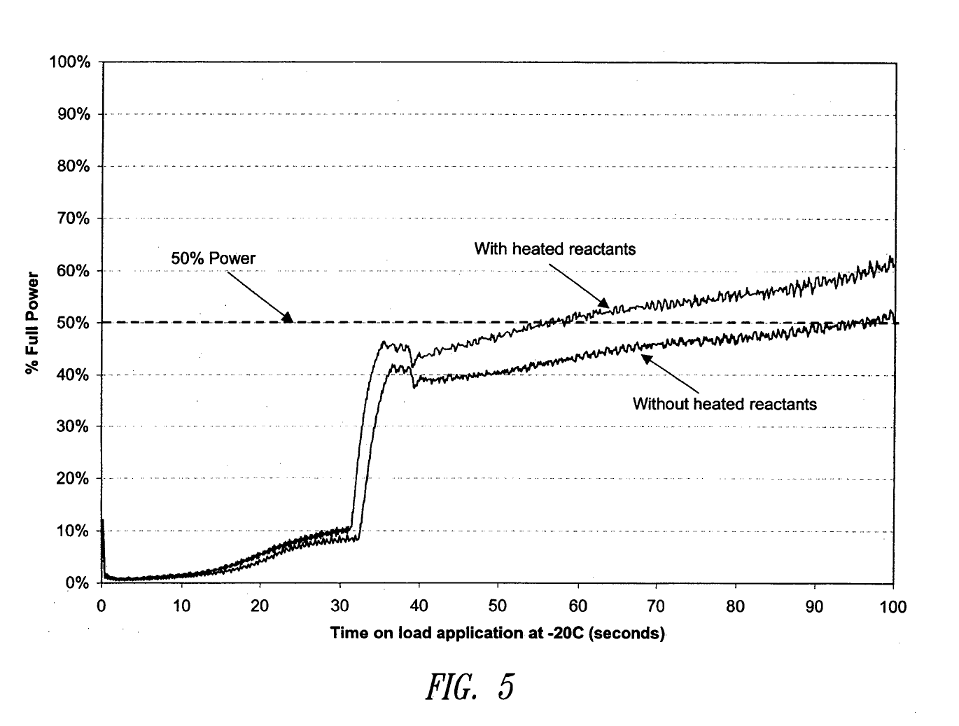

Without being bound by theory, the relationship between the water vapor pressure and the temperature of a reactant stream can be expressed by the following Goff Gratch equation:

$$\begin{matrix}{log}_{10} {p}_{w} = - 7.90298 ( \frac{373.16}{T} - 1 ) + 5.02808 {log}_{10} ( \frac{373.16}{T} ) - \\ 1.38161 ⨯ {10}^{- 7} ( {10}^{11.334 ( 1 - \frac{T}{373.16} )} - 1 ) + \\ 8.1328 ⨯ {10}^{- 3} ( {10}^{- 3.49149 ( \frac{373.16}{T} - 1} ) + {log}_{10} ( 1013.246 )\end{matrix}$$

where p_{w}=water vapor pressure in Pascals and T=temperature in degrees Celsius, which is shown in FIG. 4. Thus, if the reactant stream is warmed up as it enters the fuel cell stack during a start-up from subzero temperatures, a greater amount of product water vapor may be carried out by the reactant stream. As a result, water and/or ice accumulation in the fuel cell stack may be minimized and the time for the fuel cell stack to start-up can be accelerated.

Furthermore, without being bound by theory, by heating up at least one of the reactant streams, both the diffusion rates of the reactants to the electrocatalyst layers and the reaction rates at the electrocatalyst layers may be increased, thereby resulting in increased overall fuel cell stack performance even when the fuel cell stack is at subfreezing temperatures.

### EXAMPLES

A 20-cell fuel cell stack was operated at full power for at least 30 minutes while the temperature of the fuel cell stack was 70° C. at the inlet and 85° C. at the outlet. Hydrogen fuel and air reactant streams were supplied at 1.5 and 1.8 stoichiometry, respectively, 1.5 barg and 1.0 barg, respectively, and 58° C. and 60° C., respectively. The fuel cell stack was then shutdown by removing the load and turning off the supply of both reactant streams to the fuel cell stack. The fuel cell stack was then subjected to a two-tier dry gas purge, initiated by causing both reactant supply streams to bypass the humidifier. The cathode side of the fuel cell stack was purged by directing a low flow rate stream of oxidant to the fuel cell stack for approximately 45 seconds, followed by forced cooling of the fuel cell stack to 5° C. Both the anode and the cathode sides of the fuel cell stack were then purged by directing low flow rate streams of hydrogen and oxidant to the fuel cell stack, respectively, for about 30 seconds before freezing the fuel cell stack to −20° C.

For the first freeze-start protocol, the maximum load was drawn from the fuel cell stack for 30 seconds (i.e., average cell voltage was held as close to zero as possible) while fuel and air were supplied at 1.5 and 1.8 stoichiometry, respectively, and at 1.5 barg and 1.0 barg pressure, respectively. After this period of time, the load was ramped such that the fuel cell stack maintained an average cell voltage of 400 mV. In this case, the heated reactant inlet feed tubes (commonly referred to as “reactant hot tubes”) were turned off (i.e., not heated) prior to and during the freeze-start until the fuel cell stack reached 30° C. In addition, the fuel and air humidifiers were by-passed (i.e., fuel and air were at ambient temperature prior to entering the test station in which the fuel cell stack was tested) until the fuel cell stack reached 30° C., at which point humidified fuel and air were supplied to the fuel cell stack at 58° C. and 60° C., respectively.

For the second freeze-start protocol, the maximum load was drawn from fuel cell stack for 30 seconds while fuel and air were supplied at the conditions specified above. After this period, the load was ramped such that the fuel cell stack maintained an average cell voltage of 400 mV. In this case, the reactant hot tubes were turned on as the fuel cell stack was cooled down to −20° C., and, during the freeze-start, the fuel and air humidifiers were by-passed until the fuel cell stack reached 30° C., at which point humidified fuel and air were supplied to the fuel cell stack at 58° C. and 60° C., respectively.

The 20-cell fuel cell stack was started-up 50 times using the first freeze-start protocol and was started-up 14 times using the second freeze-start protocol. The average freeze-start time to 50% full power using the first freeze-start protocol was 102 seconds and the average freeze-start time to 50% full power using the second freeze-start protocol was only 62 seconds. Thus, turning on the reactant heat tubes prior to and during the freeze-start showed a 40% improvement in freeze-start time to 50% full power. A typical freeze-start profile showing the change in fuel cell stack power with freeze-start time is shown in FIG. 5.

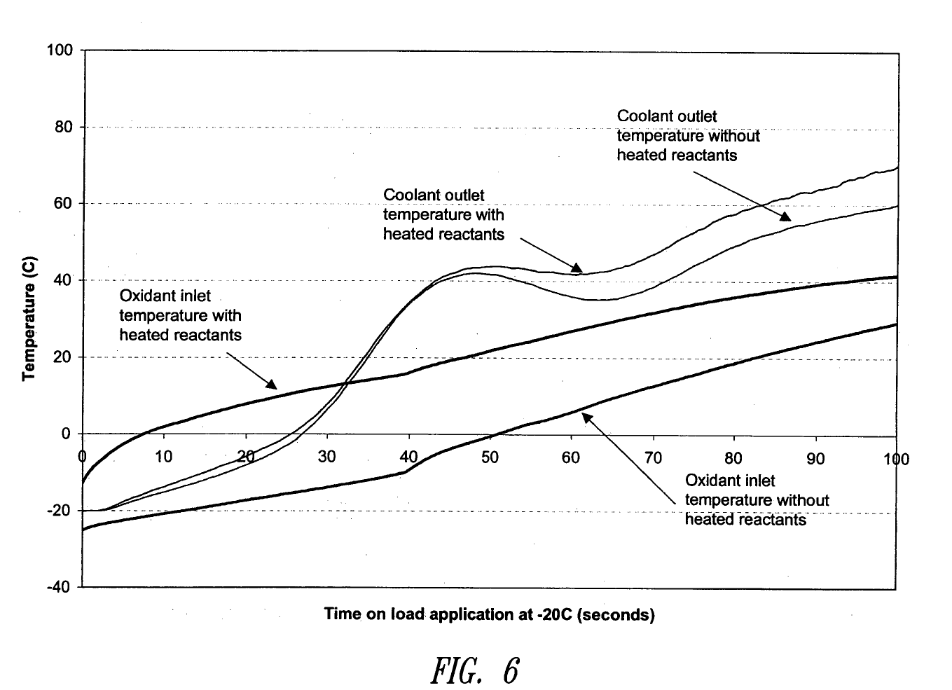

FIG. 6 shows the temperature of the coolant and the oxidant reactant stream at the inlet of the fuel cell during typical freeze-starts using the first and second freeze-start protocols, as described above. As illustrated in FIG. 6, the temperature of the fuel cell stack, as indicated by the coolant inlet temperature, was not significantly influenced by the state of the reactant hot tubes during most of the freeze-start. However, the temperature of the oxidant reactant stream, when the reactant hot tubes were turned on, was significantly higher than the temperature of the oxidant reactant stream when the reactant hot tubes were not turned on, by as much as about 30° C. during at least a portion of the freeze-start.

While particular steps, elements, embodiments and applications of the present invention have been shown and described herein for purposes of illustration, it will be understood, of course, that the invention is not limited thereto since modifications may be made by persons skilled in the art, particularly in light of the foregoing teachings, without deviating from the spirit and scope of the invention. Accordingly, the invention is not limited except as by the appended claims.

1. A method of commencing operation of an electrochemical fuel cell stack from freeze-start conditions, the method comprising:
(a) detecting the temperature of the electrochemical fuel cell stack;
(b) detecting the temperature of the ambient environment; and
(c) if the temperature of the electrochemical fuel cell stack is below the freezing temperature of water:
(i) supplying fuel and oxidant reactant streams to the electrochemical fuel cell stack, wherein the temperature of at least one reactant stream is above the temperature of the ambient environment; and
(ii) drawing electric current from the electrochemical fuel cell stack.

2. The method of claim 1 wherein the temperature of the fuel reactant stream is above the temperature of the ambient environment.

3. The method of claim 1 wherein the temperature of the oxidant reactant stream is above the temperature of the ambient environment.

4. The method of claim 1 wherein the temperatures of both the fuel and oxidant reactant streams are above the temperature of the ambient environment.

5. The method of claim 1 further comprising, if the temperature of the electrochemical fuel cell stack is below the freezing temperature of water, a step of heating the at least one reactant stream having a temperature above the temperature of the ambient environment prior to the step of supplying the reactant streams to the electrochemical fuel cell stack.

6. The method of claim 5 wherein the step of heating the at least one reactant stream comprises flowing the at least one reactant stream through a heated reactant inlet feed tube upstream of the electrochemical fuel cell stack.

7. The method of claim 6 wherein the reactant inlet feed tube is heated by an electric heater.

8. The method of claim 5 wherein the step of heating the at least one reactant stream comprises flowing the at least one reactant stream through a compressor upstream of the electrochemical fuel cell stack.

9. The method of claim 8 wherein the compressor is operated in a manner such that excess waste heat is generated.
